(19) United States
(12) Patent Application Publication
(10) Pub. No.: US 2015/0356575 A1
(43) Pub. Date: Dec. 10, 2015

(54) METHODS AND SYSTEMS FOR PREDICTING ONLINE AND IN-STORE PURCHASING

(71) Applicant: MasterCard International Incorporated, Purchase, NY (US)

(72) Inventors: Po Hu, Norwalk, CT (US); Qian Wang, Ridgefield, CT (US); Shen Xi Meng, Millwood, NY (US)

(21) Appl. No.: 14/301,025

(22) Filed: Jun. 10, 2014

(51) Int. Cl. G06Q 30/02

(52) U.S. Cl. CPC G06Q 30/0202

(57) ABSTRACT

A method and system for predicting online and in-store purchasing by a cardholder using a computer device coupled to a database are provided. The method includes receiving a set of active cardholders along with their corresponding historical transaction information, categorizing the set of cardholders based on predefined parameters, and selecting a representative subset of cardholders from the categorized set of cardholders. The method also includes analyzing the historical transaction information for each of the cardholders included within the subset of cardholders and grouping each cardholder included within the subset of cardholders to one of an online shopper group or a physical store shopper group. The method further includes developing a model based on the analyzed historical transaction information and the grouping of the cardholders and applying the model to a candidate cardholder to predict a likelihood that the candidate cardholder will purchase an item online or from a physical store.

### BACKGROUND

This disclosure relates generally to payment card transaction systems and, more particularly, to computer systems and computer-based methods for creating determining customers purchasing tendencies between physical stores and online stores.

The retail industry is changing. It was not that many years ago when all retail purchases were made by customers within a brick and mortar store (also referred to as a “physical store”). As the Internet became more popular, more and more merchants having physical stores started having an online presence on the web (also referred to as an “online store”). These merchants oftentimes would have one or more physical stores and a website providing an online store that would allow customers to make purchases online instead of at the physical store. Now, many merchants do not have any physical stores. Rather, these merchants avoid the costs associated with having physical stores, and instead, only have an online store that enables them to sell products to customers.

The dynamic that exists between online shopping and physical store shopping has resulted in many new customer practices that merchants must consider. For example, one such customer practice is called “showrooming” Showrooming is the practice of examining merchandise in a traditional physical store without purchasing it, but then shopping online to find a lower price for the same item. Online stores often offer lower prices than their physical store counterparts, because they do not have the same overhead cost. Showrooming can be costly to retailers, not only in terms of the loss of the sale, but also due to damage caused to the store's floor samples of a product through constant examination from consumers.

At least some retail merchants have tried to address the showrooming practice by slashing their own prices so that customers will purchase the merchandise within the physical store, and not go online to make the purchase. However, this approach is costly to the physical store merchants, who likely face additional costs as compared to their online counterparts due to the physical stores that they must maintain. Another approach used by physical store merchants to address showrooming is through adding value via included services and other tactics, such as making information and reviews more readily available to customers so that they might not choose to seek it out online. Again, this approach has additional costs associated with it.

### BRIEF DESCRIPTION

In one embodiment, a method of predicting online and in-store purchasing by a cardholder using a computer device coupled to a database includes receiving a set of active cardholders along with their corresponding historical transaction information, categorizing the set of cardholders based on predefined parameters, and selecting a representative subset of cardholders from the categorized set of cardholders. The method also includes analyzing the historical transaction information for each of the cardholders included within the subset of cardholders and grouping each cardholder included within the subset of cardholders to one of an online shopper group or a physical store shopper group. The method further includes developing a model based on the analyzed historical transaction information and the grouping of the cardholders and applying the model to a candidate cardholder to predict a likelihood that the candidate cardholder will purchase an item online or from a physical store.

In another embodiment, a purchase location predicting computer system (PLPS) includes a memory device and a processor in communication with the memory device, the computer system is programmed to receive a set of active cardholders along with their corresponding historical transaction information, categorize the set of cardholders based on predefined parameters, and select a representative subset of cardholders from the categorized set of cardholders. The computer system is also programmed to analyze the historical transaction information for each of the cardholders included within the subset of cardholders and group each cardholder included within the subset of cardholders to one of an online shopper group or a physical store shopper group. The computer system is further programmed to develop a model based on the analyzed historical transaction information and the grouping of the cardholders and apply the model to a candidate cardholder to predict a likelihood that the candidate cardholder will purchase an item online or from a physical store.

In yet another embodiment, one or more non-transitory computer-readable storage media has computer-executable instructions embodied thereon, wherein when executed by at least one processor, the computer-executable instructions cause the processor to receive a set of active cardholders along with their corresponding historical transaction information and categorize the set of cardholders based on predefined parameters. The computer-executable instructions also cause the processor to select a representative subset of cardholders from the categorized set of cardholders and analyze the historical transaction information for each of the cardholders included within the subset of cardholders. The computer-executable instructions further cause the processor to group each cardholder included within the subset of cardholders to one of an online shopper group or a physical store shopper group, develop a model based on the analyzed historical transaction information and the grouping of the cardholders, and apply the model to a candidate cardholder to predict a likelihood that the candidate cardholder will purchase an item online or from a physical store.

### BRIEF DESCRIPTION OF THE DRAWINGS

FIGS. 1-7 show example embodiments of the methods and systems described herein.

FIG. 1 is a schematic diagram illustrating an example multi-party payment processing system for enabling ordinary payment-by-card transactions in which merchants and card issuers do not need to have a one-to-one special relationship.

FIG. 2 is a simplified block diagram of an example processing system including a plurality of computer devices in accordance with one embodiment of the present disclosure.

FIG. 3 is an expanded block diagram of an example embodiment of a server architecture of a processing system including other computer devices in accordance with one embodiment of the present disclosure.

FIG. 4 illustrates an example configuration of a user system operated by a user, such as the cardholder shown in FIG. 1.

FIG. 5 illustrates an example configuration of a server system such as the server system shown in FIGS. 2 and 3.

FIG. 6 is a data flow diagram of a purchase location predicting system (PLPS) in accordance with an example embodiment of the present disclosure.

FIG. 7 is a table of analysis of maximum likelihood estimates that is output from a purchase location predicting computer system (PLPS) model.

### DETAILED DESCRIPTION

Embodiments of the methods and systems described herein relate to the practice of showrooming. More specifically, the systems and methods described herein are configured to use historical transaction information for a plurality of cardholders to predict which cardholders included within the plurality of cardholders will purchase a product within a predetermined period of time either online or from a physical store. The historical transaction information includes information associated with purchases initiated by cardholders using a payment card. Such historical transaction information may include, among other things, a transaction amount, a transaction date and time, a merchant identifier, a merchant category, and a merchant type which indicates whether the merchant is an online merchant or a physical store merchant.

In the example embodiment, a customer predicting (“CP computing device”) computer device is in a communication with a payment processing system. The payment processing system is configured to process payment card transactions that are initiated by cardholders. The payment processing system includes one or more memory devices that are used to store transaction information generated from the processing of payment transactions. The CP computing device is configured to receive transaction information from the payment processing system and further process the transaction information. For example, the CP computing device is configured to (1) retrieve a set of active cardholders along with their corresponding historical transaction information from the one or more processing system memory devices, (2) categorize the set of retrieved cardholders based on predefined parameters, (3) select a representative subset of cardholders from the categorized set of cardholders, (4) analyze the historical transaction information for each of the cardholders included within the subset of cardholders, (5) group each cardholder included within the subset of cardholders to one of two groups, namely an online shopper group or a physical store shopper group, (6) develop a logistic regression model based on the analyzed historical transaction information and the grouping of the cardholders, wherein the model is for predicting whether a candidate cardholder is more likely to purchase an item in the future online or from a physical store, and (7) apply the model to all of the cardholders included within the set of cardholders.

The methods and systems described herein may be implemented using computer programming or engineering techniques including computer software, firmware, hardware or any combination or subset thereof, the technical effect of the methods and systems may be achieved by performing at least one of the following steps: (a) retrieve a set of active cardholders along with their corresponding historical transaction information from the one or more processing system memory devices, (b) categorize the set of retrieved cardholders based on predefined parameters, (c) select a representative subset of cardholders from the categorized set of cardholders, (d) analyze the historical transaction information for each of the cardholders included within the subset of cardholders, (e) group each cardholder included within the subset of cardholders to one of two groups, namely an online shopper group or a physical store shopper group, (f) develop a logistic regression model based on the analyzed historical transaction information and the grouping of the cardholders, wherein the model is for predicting whether a candidate cardholder is more likely to purchase an item in the future online or from a physical store, and (g) apply the model to all of the cardholders included within the set of cardholders.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

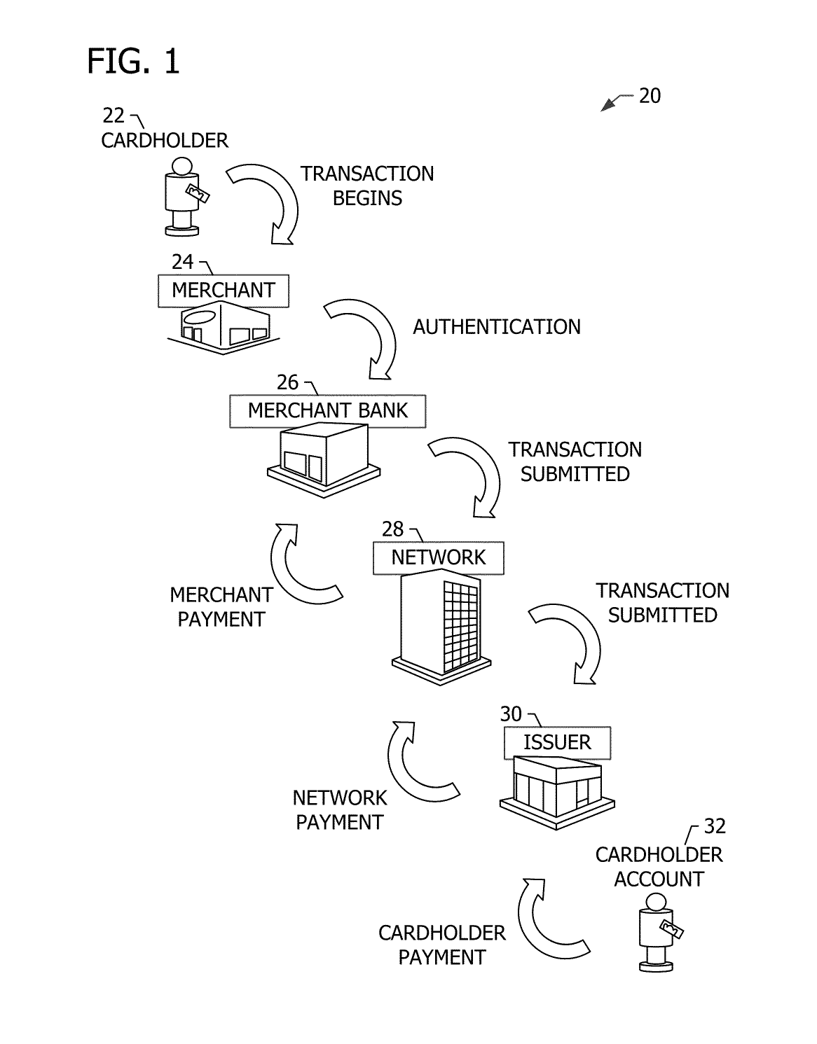

FIG. 1 is a schematic diagram illustrating an example multi-party payment processing system 20 for enabling ordinary payment-by-card transactions in which merchants 24 and card issuers 30 do not need to have a one-to-one special relationship. Embodiments described herein may relate to a transaction card system, such as a payment card network operated by MasterCard International Incorporated. The payment card network, as described herein, is a four-party payment card interchange network that includes a plurality of special purpose processors and data structures stored in one or more memory devices communicatively coupled to the processors, and a set of proprietary communications standards promulgated by MasterCard International Incorporated for the exchange of financial transaction data and the settlement of funds between financial institutions that are members of the payment card network.

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment processing system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

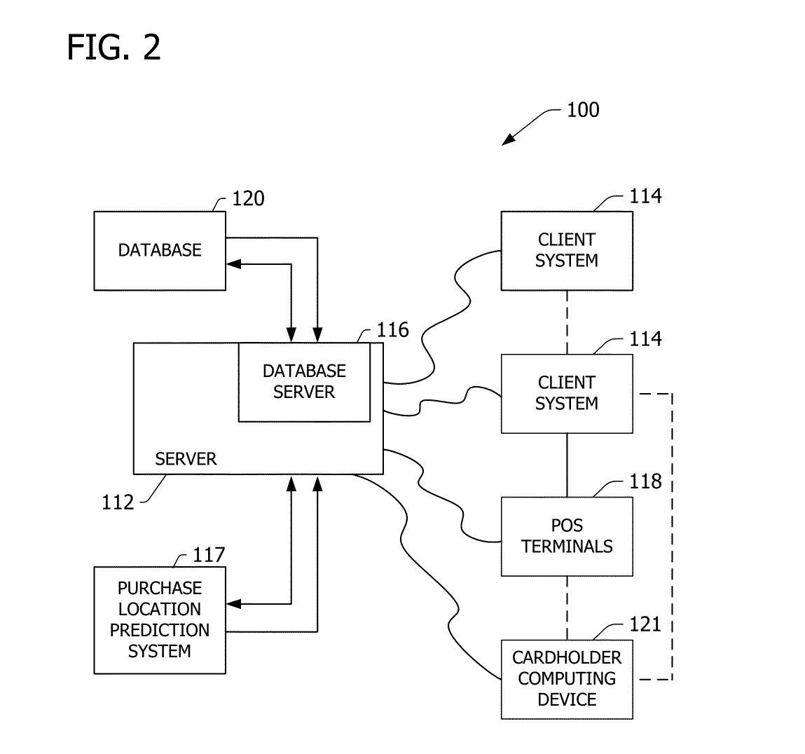

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, seasonal information, information regarding the purchased item and/or service, and/or other suitable information, is associated with a transaction and transmitted between parties to the transaction as transaction data, and may be stored by any of the parties to the transaction. In the example embodiment, when cardholder 22 purchases goods, such as from a physical store or an online store, at least partial purchasing location information is transmitted during the clearance process as transaction data. When interchange network 28 receives the purchasing location information, interchange network 28 routes the purchasing location information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example processing system 100 including a plurality of computer devices in accordance with one embodiment of the present disclosure. In the example embodiment, system 100 may be used for performing payment-by-card transactions and/or modeling customer purchase location information received as of part processing the financial transaction. For example, system 100 may store purchase location information data in a merchant database. Many merchants have both physical stores and online stores from which customers may make purchases. The purchase location information data may include for a physical store, a street name, a street number, a unit number, a unit name, a street direction, a street suffix, a street number prefix, and/or a floor number. The purchase location information data may include, for an online store, a uniform resource locator (URL) for the site or other web page addressing information. System 100 may receive financial transaction data as part of processing transactions. System 100 is configured to process financial transaction data and convert it into a probability that a customer or group of customers to make purchases either online or in a physical store. The financial transaction data can then be compared to marketing data stored in a merchant database, such as database 120.

More specifically, in the example embodiment, system 100 includes a server system 112, and a plurality of client sub-systems, also referred to as client systems 114, connected to server system 112, purchase location predicting computer system (PLPS) 117, and a cardholder computing device 121. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112, and may be connected to cardholder computing device 121. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store purchase location data associated with a customer for processing according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment processing system, a biller, and/or a purchasing location tracking system. The purchasing location tracking system may be associated with interchange network 28 or with an outside third party in a contractual relationship with interchange network 28. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

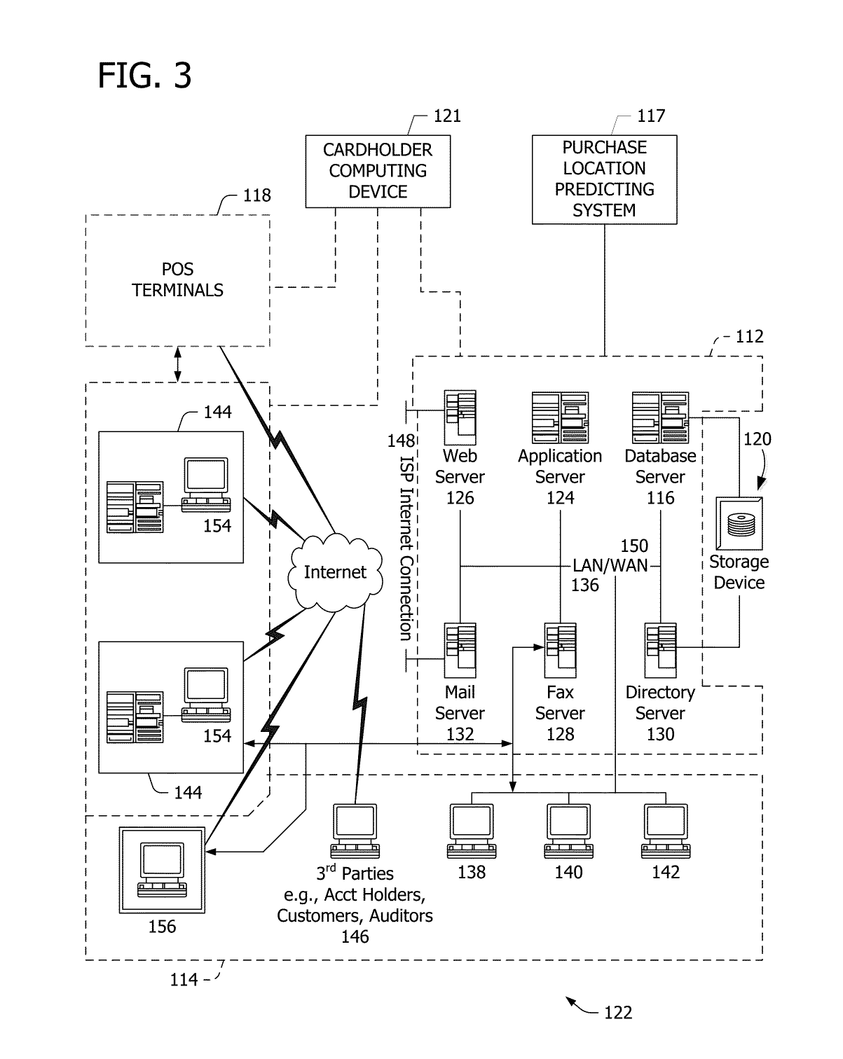

FIG. 3 is an expanded block diagram of an example embodiment of a server architecture of a processing system 122 including other computer devices in accordance with one embodiment of the present disclosure. Components in processing system 122, identical to components of system 100 (shown in FIG. 2), are identified in FIG. 3 using the same reference numerals as used in FIG. 2. Processing system 122 includes server system 112, client systems 114, and POS terminals 118. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access processing system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

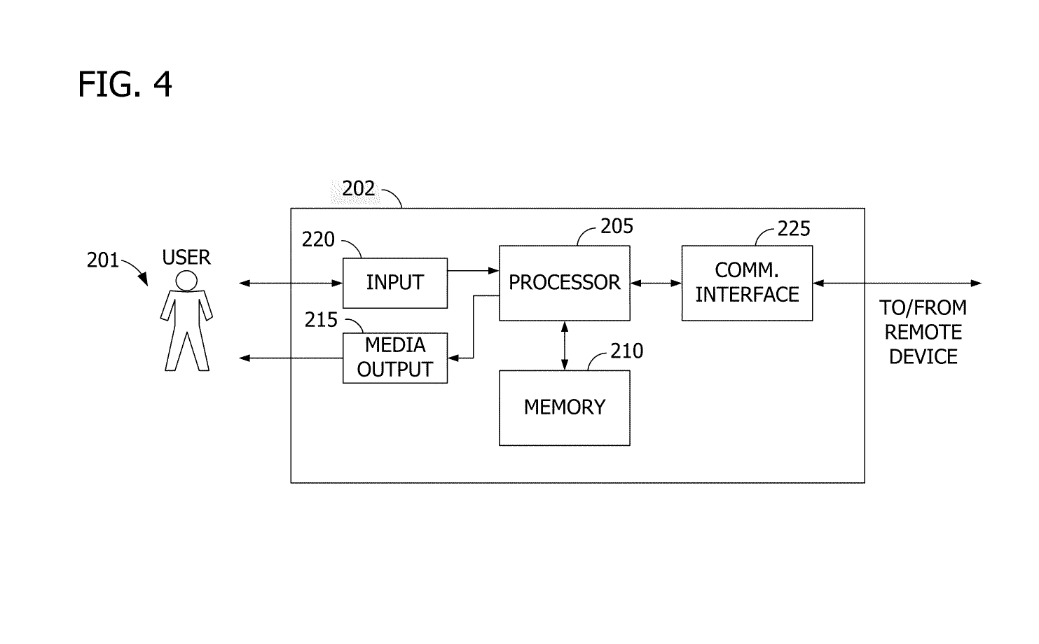

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

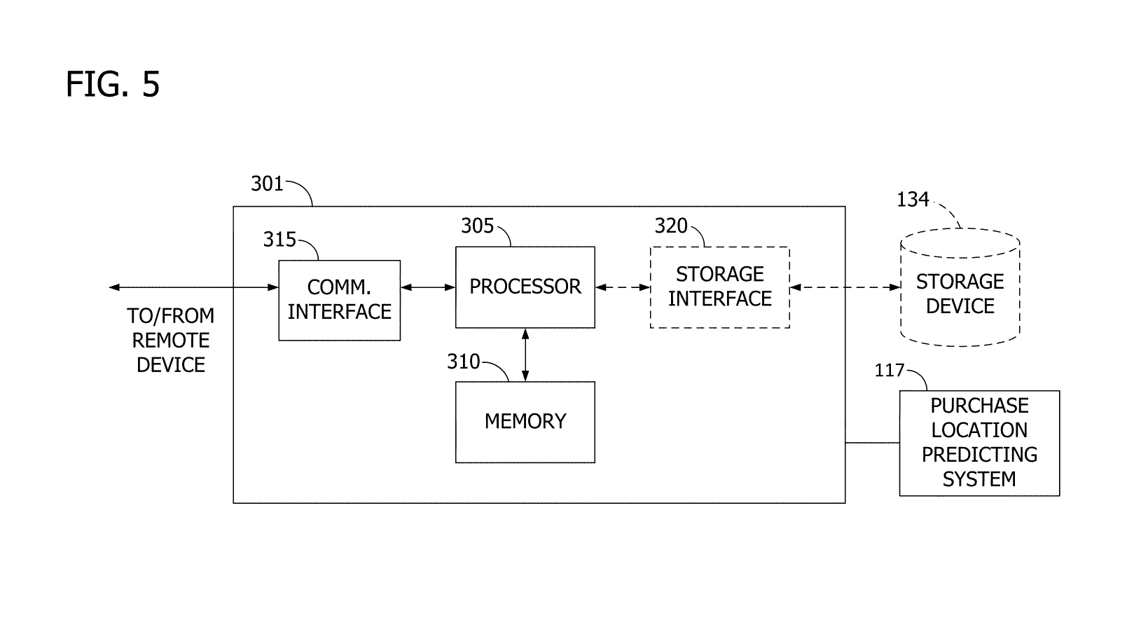

FIG. 5 illustrates an example configuration of a server system 301 such as server system 112 (shown in FIGS. 2 and 3). Server system 301 may include, but is not limited to, database server 116, application server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from clinet system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

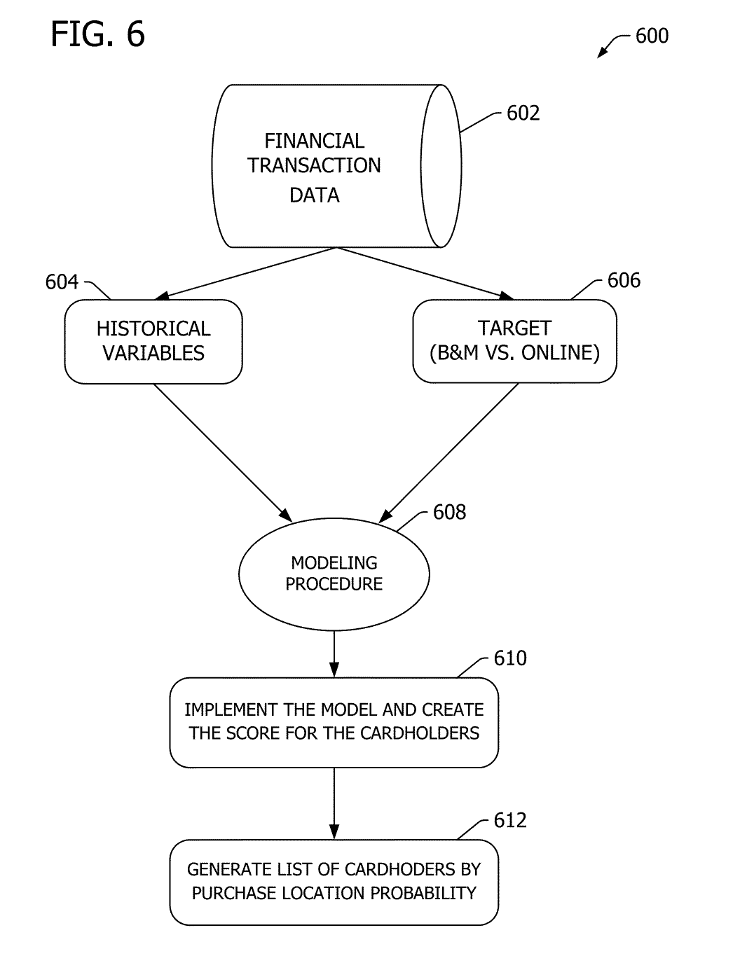

FIG. 6 is a data flow diagram 600 of a purchase location predicting system (PLPS) in accordance with an example embodiment of the present disclosure. In the example embodiment, financial transaction data 602 stored within one or more servers of a financial transaction interchange system is accessed. Historical variables 604 relating to the purchase activity of a plurality of cardholders are extracted according to predetermined parameters. In one embodiment, the parameters relate to the timing of purchases with respect to holidays or other seasonal periods. For example, purchases of outdoor durable goods may be pronounced during a change of seasons. Cardholders may purchase snow blowers in the late fall and lawn tractors in the early spring. Similarly, certain classes of goods may be purchased near particular holidays more other than others (i.e., flowers near Mothers' Day, candy near Valentine's Day, etc.). Merchant data 606 that indicates whether a purchase was made at a physical store or an online store is also extracted. Historical variables information 604 for the plurality of cardholders and merchant data 606 are used in a modeling procedure 608, which facilitates predicting which cardholders included within the plurality of cardholders will purchase a product within a predetermined period of time either online or from a physical store. Modeling procedure 608 includes sampling the active cardholders' historical transactional information, classifying the historical transactional information using the historical transactional information in various categories at different time periods to determine trends in developing a model, such as, but not limited to a logistic regression model. The model outputs a score 610 relative to predicting which card holder or group of cardholders 612 have a high likelihood of in-store (or online) shopping at certain times at certain stores.

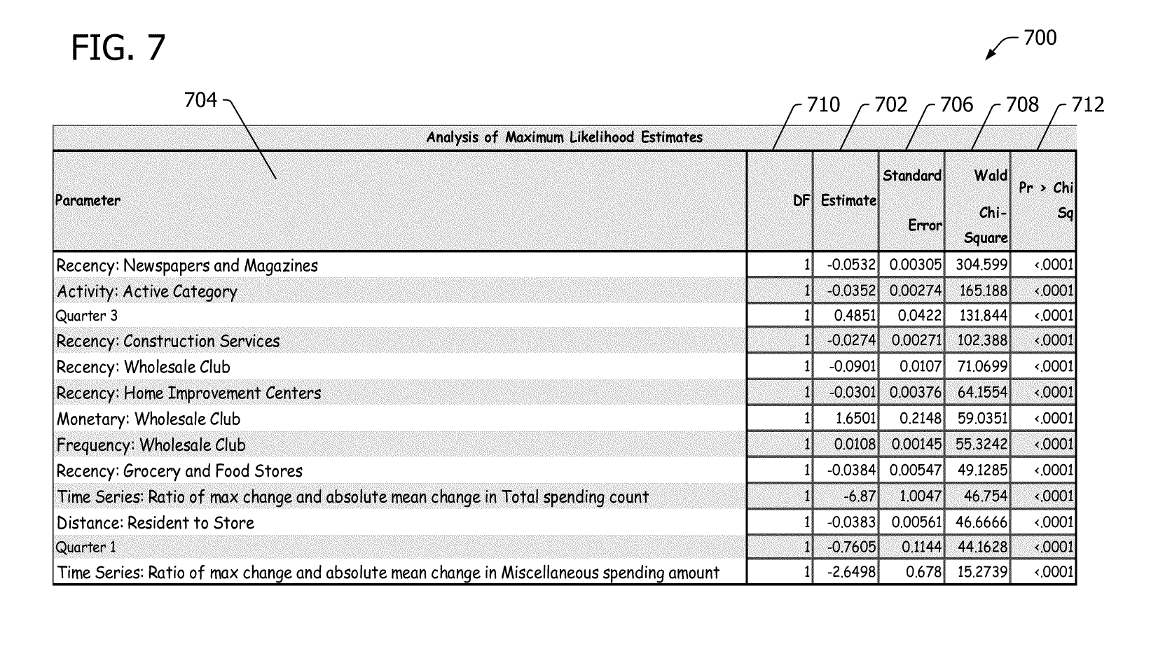

FIG. 7 is a table 700 of analysis of maximum likelihood estimates that is output from a purchase location predicting computer system (PLPS) model. In the example embodiment, a statistical regression procedure, such as, but not limited to, logistic regression is used to establish an equation for classifying new historical transactional information using the historical transactional information in various categories at different time periods. In general, regression analysis is the analysis of the relationship between one variable and another set of variables. The relationship is expressed as an equation. Using the equation it is possible to predict a response, or dependent variable from a function of regressor variables and parameters. Regressor variables are sometimes referred to as independent variables or predictors. Logistic regression analysis is used in the present analysis rather than standard regression analysis, or linear regression because of the binary or dichotomous nature of the response variable, which indicates that a cardholder is more likely to purchase a product in a physical store than an online store or vice versa. Logistic regression is used because it uses the maximum likelihood estimation procedure to evaluate the effectiveness of the regression and this procedure works with a response variable that is dichotomous. The training process of logistic regression operates by choosing a classifier to separate the classes as well as possible. For logistic regression, the criterion for a good separation is the maximum of a conditional likelihood.

Table 700 displays a maximum likelihood estimate 702 of a parameter 704, an estimated standard error 706, a Wald Chi-Square statistic 708, a degrees of freedom 710 of the Wald chi-square statistic, and a p-value 712 of the Wald chi-square statistic. In an embodiment, estimated standard error 706 is computed as the square root of the corresponding diagonal element of an estimated covariance matrix, Wald Chi-Square statistic 708 is computed as the square of the parameter estimate divided by its standard error estimate, and degrees of freedom 710 of the Wald chi-square statistic has a value of 1 unless the corresponding parameter is redundant or infinite, in which case the value is 0. In various embodiments, parameters and the maximum likelihood estimate values will be different for different selections of historical financial information, categories of interest, time period, and season.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205 and 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The above-described embodiments of a method and system of predicting whether a cardholder is more or less likely to buy a particular product or category of products within a predetermined time period at a physical store versus an online store provides a cost-effective and reliable means for using historical transaction information for the cardholder and other cardholders to generate a model. More specifically, the methods and systems described herein facilitate modeling a predication algorithm for a plurality of different categories of goods. As a result, the methods and systems described herein facilitate providing information for marketing to groups of cardholders according to their likelihood of purchasing in a physical store or an online store in a cost-effective and reliable manner.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-based method for predicting online and in-store purchasing by a cardholder, said method implemented using a computing device in communication with one or more memory devices, said method comprising:
receiving a set of active cardholder information and historical transaction information corresponding to the set of active cardholder information;
categorizing the set of active cardholder information based on predefined parameters;
selecting a representative subset of cardholder information from the categorized set of active cardholder information;
analyzing the historical transaction information for each of the cardholders included within the subset of cardholder information;
grouping each cardholder included within the subset of cardholder information to one of an online shopper group or a physical store shopper group;
developing a model based on the analyzed historical transaction information and the grouping of the cardholders; and
applying the model to a candidate cardholder to predict a likelihood that the candidate cardholder will purchase an item online or from a physical store.

2. The computer-based method of claim 1, wherein the model is applied to all of the cardholders included within the set of cardholder information to predict the likelihood that each cardholder included within the set of cardholder information will purchase an item online or from a physical store.

3. The computer-based method of claim 1, wherein the model is configured to predict the likelihood that a candidate cardholder will purchase a type of item within a predetermined period of time online or from a physical store.

4. The computer-based method of claim 1, wherein the receiving a set of active cardholder information further includes receiving a set of active cardholder information and corresponding historical transaction information from payment card transaction data for payments processed through a payment network.

5. The computer-based method of claim 1, wherein the model includes a seasonal aspect, the seasonal aspect predictively indicating whether the cardholder will make the purchase during a particular season including at least one of a winter season, a summer season, a fall season, a spring season, and a holiday season.

6. The computer-based method of claim 1, wherein the model is specific to a particular merchant category.

7. The computer-based method of claim 1, wherein the model includes a logistic regression analysis.

8. A purchase location predicting computer system (PLPS), the computer system comprising a memory device and a processor in communication with the memory device, the computer system programmed to:
receive a set of active cardholder information and historical transaction information corresponding the set of active cardholder information;
categorize the set of active cardholder information based on predefined parameters;
select a representative subset of active cardholder information from the categorized set of active cardholder information;
analyze the historical transaction information for each of the cardholders included within the subset of active cardholder information;
group each cardholder included within the subset of active cardholder information to one of an online shopper group or a physical store shopper group;
develop a model based on the analyzed historical transaction information and the grouping of the cardholders; and
apply the model to a candidate cardholder to predict a likelihood that the candidate cardholder will purchase an item online or from a physical store.

9. The computer system of claim 8, wherein said computer system is programmed to apply the model to all of the cardholders included within the set of active cardholder information to predict the likelihood that each cardholder included within the set of cardholders will purchase an item online or from a physical store.

10. The computer system of claim 8, wherein said computer system is programmed to predict, using the model, the likelihood that a candidate cardholder will purchase a type of item within a predetermined period of time online or from a physical store.

11. The computer system of claim 8, wherein said computer system is programmed to receive a set of active cardholder information and historical transaction information corresponding to the set of active cardholder information from payment card transaction data for payments processed through a payment network.

12. The computer system of claim 8, wherein said computer system is programmed to determine, using the model, whether the cardholder will make the purchase during a particular season of the year including at least one of a winter season, a summer season, a fall season, a spring season, and a holiday season.

13. The computer system of claim 8, wherein said computer system is programmed to model a specific merchant category.

14. One or more non-transitory computer-readable storage media having computer-executable instructions embodied thereon, wherein when executed by at least one processor, the computer-executable instructions cause the processor to:
receive a set of active cardholder information and historical transaction information corresponding the set of active cardholder information;
categorize the set of active cardholder information based on predefined parameters;
select a representative subset of active cardholder information from the categorized set of active cardholder information;
analyze the historical transaction information for each of the cardholders included within the subset of active cardholder information;
group each cardholder included within the subset of cardholders to one of an online shopper group or a physical store shopper group;
develop a model based on the analyzed historical transaction information and the grouping of the cardholders; and
apply the model to a candidate cardholder to predict a likelihood that the candidate cardholder will purchase an item online or from a physical store.

15. The computer-readable storage media of claim 14, wherein the computer-executable instructions further cause the processor to apply the model to all of the cardholders included within the set of active cardholder information to predict the likelihood that each cardholder included within the set of active cardholder information will purchase an item online or from a physical store.

16. The computer-readable storage media of claim 14, wherein the computer-executable instructions further cause the processor to predict, using the model, the likelihood that a candidate cardholder will purchase a type of item within a predetermined period of time online or from a physical store.

17. The computer-readable storage media of claim 14, wherein the computer-executable instructions further cause the processor to receive a set of active cardholder information and historical transaction information corresponding to the set of active cardholder information from payment card transaction data for payments processed through a payment network.

18. The computer-readable storage media of claim 14, wherein the computer-executable instructions further cause the processor to determine, using the model, whether the cardholder will make the purchase during a particular season of the year including at least one of a winter season, a summer season, a fall season, a spring season, and a holiday season.

19. The computer-readable storage media of claim 14, wherein the computer-executable instructions further cause the processor to model a specific merchant category.

20. The computer-readable storage media of claim 14, wherein the computer-executable instructions further cause the processor to model a specific merchant category using a logistic regression analysis.
